(19) United States
(12) Patent Application Publication
(10) Pub. No.: US 2024/0198429 A1
(43) Pub. Date: Jun. 20, 2024

(54) DAMPING MACHINING METHOD FOR LONG WORKPIECE

(71) Applicants: NAKAMURA-TOME PRECISION INDUSTRY CO., LTD., Hakusan-shi (JP); KANAZAWA INSTITUTE OF TECHNOLOGY, Nonoichi-shi (JP)

(72) Inventors: Yuta KAWAGOE, Hakusan-shi (JP); Kenichi Nakanishi, Hakusan-shi (JP); Yoshitaka Morimoto, Nonoichi-shi (JP); Akio Hayashi, Nonoichi-shi (JP)

(73) Assignees: NAKAMURA-TOME PRECISION INDUSTRY CO., LTD., Hakusan-shi (JP); KANAZAWA INSTITUTE OF TECHNOLOGY, Nonoichi-shi (JP)

(21) Appl. No.: 18/592,789

(22) Filed: Mar. 1, 2024

Related U.S. Application Data
(63) Continuation of application No. PCT/JP22/28710, filed on Jul. 26, 2022.

(30) Foreign Application Priority Data
Sep. 30, 2021 (JP) 2021-160206

(51) Int. Cl. B23B 1/00

(52) U.S. Cl. CPC B23B 1/00

(57) ABSTRACT

A damping machining method for a long workpiece includes, when rotating the long workpiece in a state in which both end portions of the long workpiece are respectively held and cutting an outer circumferential portion of the long workpiece with a turning tool, applying a torsional load to the long workpiece.

### CROSS REFERENCE TO RELATED APPLICATIONS

This application is a continuation of International Patent Application No. PCT/JP2022/028710, having an international filing date of Jul. 26, 2022, which designated the United States, the entirety of which is incorporated herein by reference. Japanese Patent Application No.2021-160206 filed on Sep. 30, 2021 is also incorporated herein by reference in its entirety.

### BACKGROUND OF THE INVENTION

The present disclosure relates to a machining method that uses a damping effect to prevent chattering vibration from occurring when a long workpiece is cutting.

When a relatively long workpiece is turned by a machine tool such as a lathe, in some cases, the workpiece vibrates, so-called chattering occurs, and desired machining cannot be performed.

As means for preventing chattering vibration from occurring during such machining of the workpiece, methods described below have been adopted.
(1) A method of monitoring a relation between rotating speed of a spindle and fluctuation amplitude and a fluctuation period of a workpiece and controlling machining conditions (Patent Documents JP-A-2021-70138 and JP-A-2012-91283).
(2) An intermediate part of a workpiece is held by a swinging stop device and two cutting tools are placed facing both sides of the workpiece (Patent Document 3).
(3) Improvement of a turning tool shape; for example, a nose R of a tip is reduced in size.
(4) Note that the applicant previously proposed a method of controlling an axial force in a tensile direction while applying the axial force to a long workpiece (Patent Document JP-A-2012-196748). However, the present disclosure makes it possible to, with new knowledge, apply damping action.

### BRIEF DESCRIPTION OF THE DRAWINGS

FIG. 1 illustrates a state in which a long workpiece is machined in a both-ended holding manner.

FIG. 2A illustrates a frequency analysis chart in the case in which the long workpiece is cut in a state in which a torsional load is not applied to the long workpiece.

FIG. 2B illustrates a frequency analysis chart in the case in which the long workpiece is cut in a state in which a torsional load is applied to the long workpiece.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

An object of the disclosure is to provide a damping machining method effective for, when a long workpiece is cutting, preventing chattering vibration from occurring in the workpiece.

In accordance with one of some embodiments, a damping machining method for a long workpiece includes, when rotating the long workpiece in a state in which both end portions of the long workpiece are respectively held and cutting an outer circumferential portion of the long workpiece with a turning tool, applying a torsional load to the long workpiece.

In the disclosure, a long workpiece is particularly effective for a workpiece, in which a ratio of length L to an outer diameter D of the workpiece is L/D=5 or larger.

The state in which both the end portions of the long workpiece are respectively held means causing a force in a torsional direction (a torsional load) to act on the long workpiece in turning. Such state can be realized by holding both ends of the long workpiece using two spindles whose rotation are controlled. Alternatively, if one end of the workpiece is held in a chuck and the other end of the workpiece is held with a tailstock or various auxiliary tools, such state can be realized by adding a resistance force in a rotation direction of the workpiece by the tailstock or the like.

A representative aspect in the disclosure is an aspect in which a first spindle and a second spindle disposed to face each other on a same axis and caused to hold both the end portions of the long workpiece are prepared, and the torsional load is applied to the long workpiece by giving rotating speed commands different from each other to the first spindle and the second spindle respectively.

When the rotating speed commands different from each other are respectively given by an NC control device or the like and the long workpiece is machined in a both-ended holding manner by the first spindle and the second spindle in this way, the long workpiece is rotation-controlled in a state in which a torsional load involved in a difference between rotating speeds occurs in the first spindle and the second spindle.

In this case, when the rotating speed commands different from each other are given to the first spindle and the second spindle, at least one rotating speed of the rotating speed commands to one or both of the first spindle and the second spindle can be changed or fluctuated. Further, at least one of the first spindle and the second spindle may be controlled to move in an approaching direction and a separating direction and a tensile force or a compression force can be applied to the long workpiece.

When the tensile force or the compression force applied to the long workpiece is variably adjusted according to the length and the diameter of the long workpiece, an edge shape of a tool, or the like, apparent rigidity improvement occurs in the long workpiece and acts to prevent chattering vibration from occurring.

In the disclosure, when a long workpiece is turned in a both-ended holding manner, an external force in a torsional direction (a torsional load) is applied to the workpiece to temporarily improve the rigidity of the long workpiece and temporarily change the direction of a turning load by a turning tool. This makes it possible to easily prevent chattering vibration from occurring in the long workpiece.

Exemplary embodiments are described below. Note that the following exemplary embodiments do not in any way limit the scope of the content defined by the claims laid out herein. Note also that all of the elements described in the present embodiment should not necessarily be taken as essential elements.

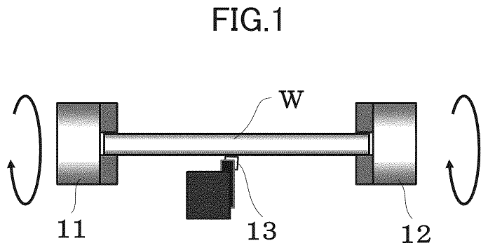

FIG. 1 illustrates an example of machining in a both-ended holding manner in which one end portion of a long workpiece W is chuck-held by a first spindle 11 and the other end portion is held by a second spindle 12.

As the long workpiece W, a workpiece made of S45C and having an outer diameter of 11 to 13 mm and length of 300 mm was used.

Gripping margins by the spindles were respectively set to 20 mm.

Cutting conditions were set to a cut t: 0.3 mm and feeding speed f: 0.15 mm/rev.

First, a rotating speed command of 1800/min was set in the first spindle and the second spindle was caused to follow the first spindle in a free state.

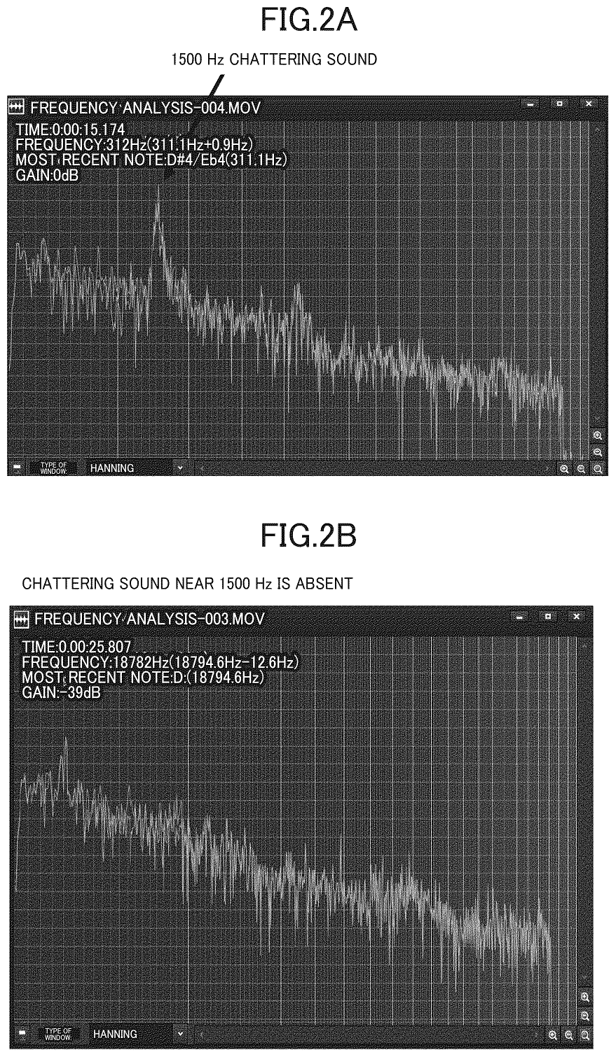

When the long workpiece W was cut by a turning tool 13 under these conditions, a chatter mark occurred in the center of the workpiece. When a frequency analysis was performed, chattering vibration occurred near 1500 Hz as indicated by a chart of the frequency analysis illustrated in FIG. 2A.

Next, rotating speed designation of 1800/min was set in the first spindle and a rotating speed command of 1750/min different from 1800/min was set in the second spindle to apply a torsional load to the long workpiece. The same turning was performed on the long workpiece by the turning tool 13.

This makes it possible to normally perform turning without a chattering mark occurring in the long workpiece. A frequency analysis result at that time is illustrated in FIG. 2B.

It is seen that the chattering vibration near 1500 Hz that occurs in FIG. 2A disappears.

It was made evident from the comparative experiment explained above that, when the long workpiece is cutting while an external force is applied thereto in a torsional direction, damping action occurs in the long workpiece and occurrence of chattering vibration can be suppressed.

Here, the magnitude of the torsional load applied to the long workpiece need only be set as appropriate according to the length and the outer diameter of the workpiece.

When the turning is performed in a both-ended holding state of the long workpiece by the first spindle and the second spindle, it is possible to adjust the magnitude of the torsional load according to a turning state of the long workpiece by not only setting a difference between the rotating speed commands for the first spindle and the second spindle but also fluctuating the rotating speed command for one or both of the spindles within a predetermined range on a low speed side and a high speed side.

Further, the rigidity of the long workpiece is also temporarily improved by applying a tensile force or a compression force along the axial direction of the long workpiece according to the torsional load. It is possible to suppress chattering vibration. It is also possible to adjust the tensile force or the compression force depending on the change of thermal deformation of the long workpiece.

The disclosure can be widely applied when a long workpiece is turned.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

1. A damping machining method for a long workpiece comprising, when rotating the long workpiece in a state in which both end portions of the long workpiece are respectively held and cutting an outer circumferential portion of the long workpiece with a turning tool, applying a torsional load to the long workpiece.

2. The damping machining method for the long workpiece according to claim 1, wherein a first spindle and a second spindle disposed to face each other on a same axis and caused to hold both the end portions of the long workpiece are prepared, and the torsional load is applied to the long workpiece by giving rotating speed commands different from each other to the first spindle and the second spindle respectively.

3. The damping machining method for the long workpiece according to claim 2, wherein, when the rotating speed commands different from each other are given to the first spindle and the second spindle, at least one rotating speed of the rotating speed commands to one or both of the first spindle and the second spindle is fluctuated.

4. The damping machining method for the long workpiece according to claim 2, wherein at least one of the first spindle and the second spindle is controlled to move in an approaching direction and a separating direction, and a tensile force or a compression force is applied to the long workpiece.

5. The damping machining method for the long workpiece according to claim 3, wherein at least one of the first spindle and the second spindle is controlled to move in an approaching direction and a separating direction, and a tensile force or a compression force is applied to the long workpiece.
